(19) United States
(12) Patent Application Publication
(10) Pub. No.: US 2014/0324709 A1
(43) Pub. Date: Oct. 30, 2014

(54) PATENTABILITY DETERMINATION

(71) Applicant: Tata Consultancy Services Limited, Mumbai (IN)

(72) Inventor: Arnab Sinha, Amsterdam (NL)

(73) Assignee: Tata Consultancy Services Limited, Mumbai (IN)

(21) Appl. No.: 14/086,707

(22) Filed: Nov. 21, 2013

(30) Foreign Application Priority Data
Apr. 30, 2013 (IN) 1574/MUM/2013

(51) Int. Cl. G06Q 50/18; G06F 17/30

(52) U.S. Cl. CPC G06Q 50/184; G06F 17/30011
USPC 705/310

(57) ABSTRACT

The present subject matter discloses systems and methods for patentability determination of an inventive idea in an organization. In one implementation, the method for patentability determination in the organization comprises receiving high-level functionalities and granular-level functionalities of the inventive idea at a patentability determination system from an end user. Next, the end user provides importance-level inputs for each of the granular-level functionalities at the patentability determination system. The method further comprises receiving matching-level inputs for each of the granular-level functionalities against prior art documents at the patentability determination system from a plurality of evaluators. Based on the importance-level inputs and the matching-level inputs, an overall patentability index value of the granular-level functionalities is calculated. The overall patentability index value of the granular-level functionalities is then compared with a predetermined threshold to determine patentability of the inventive idea.

### TECHNICAL FIELD

The present subject matter relates, in general, to patent management and, in particular, to systems and methods for patentability determination of an inventive idea.

### BACKGROUND

Innovation is becoming a key factor for many enterprises to succeed in an increasingly globally competitive world. In recent times, many enterprises have appreciated that innovation plays a role not just in the development of products and services but in every process of an enterprise. This has led to the development of formal mechanisms in enterprises to capture and manage innovation via intellectual property (IP) rights. With the increasing economic relevance of IP rights, enterprises focus on generating, acquiring, protecting, evaluating and managing innovation as IP assets. However, for many enterprises and professionals who are not expert in IP management, IP rights generally, and patent rights specifically, related to the innovations remain somewhat of a mystery to fully understand, assess, and value.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates a network environment implementing a patentability determination system, according to an embodiment of the present subject matter.

FIG. 2 illustrates the patentability determination system, according to an embodiment of the present subject matter.

FIG. 3 illustrates a method of determining a patentability of an inventive idea, according to an embodiment of the present subject matter

### DETAILED DESCRIPTION

Systems and methods for patentability determination of an inventive idea are described herein. The systems and methods can be implemented in a variety of computing systems. Examples of such computing systems include, but are not restricted to, mainframe computers, workstations, personal computers, desktop computers, minicomputers, servers, multiprocessor systems, laptops, network servers, and the like.

Generally, intellectual property (IP) assets include proprietary concepts, which may be protected as IP, published in defensive publications, or held privately as a trade secret. For protecting as IP, the proprietary concepts may be processed and filed as applications for patents, trademarks, service marks, copyrights, and/or the like. Further, in order to save time, cost, and resources associated with securing inventive ideas as patent rights, generally, the patentability of the inventive idea is determined before filing the inventive idea as a patent application with an appropriate intellectual property office. For example, for the patentability determination, an inventor may determine whether the inventive idea (i) contains a patentable subject matter, (ii) is new, and (iii) is non-obvious over existing prior arts. However, with current practices, an inventor has to contact and engage a patent professional, for example, a patent lawyer or a patent agent, for the patentability determination of the inventive idea when considering whether to pursue patent protection for the inventive idea. The patentability determination performed by the patent professional is generally not a structured approach that can be consistently followed and has no metric for quantification or assessment of the search. Thus, such patentability determination does not provide a value or benchmark for qualification of the inventive idea being filed as patent application. This may lead to a biased or non-accurate quantification or assessment of the patentability determination of the inventive idea as the patentability determination is generally performed by a single patent professional.

According to the present subject matter, systems and methods for patentability determination of an inventive idea are described. It should be appreciated by those skilled in the art that though the systems and methods for patentability determination of the inventive idea are described in the context of patentability determination of the inventive idea in an enterprise, the same should not be construed as a limitation. For example, the systems and methods for patentability determination of the inventive idea may be implemented for various other purposes, such as for generating and implementing various frameworks of patent management, evaluating a patent portfolio, and determining a maturity level of an enterprise in managing patents.

In a large enterprise, the intellectual property (IP) is spread out across different business units, technologies, products, and service groups. When in an enterprise, an inventor comes up with an inventive idea or a technical enhancement in a field, the inventor may capture the inventive idea within an invention disclosure file (IDF). The IDF normally includes inventor details, inventive idea details, and keywords related to the inventive idea. Once the IDF is prepared, the inventor may submit the same to a patentability determination system. Upon submission, the patentability determination system initiates a process to receive one or more functionalities captured by the inventive idea from the inventor. The functionalities may be understood as different features of the inventive idea, or may be understood as different technical advancements captured by the inventive idea in a technical field.

In an example, the inventor may provide the one or more functionalities under two categories, i.e., high-level functionalities and granular-level functionalities. The high-level functionalities capture main features of the inventive idea, while the granular-level functionalities capture sub-features of the main features of the inventive idea. Further, in an example, each of the granular-level functionalities is associated with a high-level functionality. In accordance with the present subject matter, an evaluation of the granular-level functionalities is performed to determine the patentability of the inventive idea.

Once the granular-level functionalities and the high-level functionalities are received from the inventor, the patentability determination system receives importance-level inputs from the inventor for the granular-level functionalities. The importance-level inputs are received for setting different priorities for the one or more functionalities of the inventive idea. Examples of the importance-level input may include information, low importance, medium importance, high importance, and unique. Once the importance-level inputs are received for all the granular-level functionalities, the importance-level inputs are transformed into importance values. In an example, the importance values are represented in the form of percentage (%) values. For example, importance level input of information may have 0% importance while that of unique may have 100% importance.

Thereafter, based on phrases of the one or more functionalities, especially the granular-level functionalities, a prior art search is conducted for the inventive idea by an end user, say an inventor or a patent professional. Such prior art search may be more focused on the inventive idea as the search would be conducted on functionality-based search, rather than conventional keyword-based search. In an example, prior art documents found in the prior art search may include, but are not limited to, issued patents, published patent applications, non-patent literature, published idea description, published technical documents and other publications.

Once the prior art documents are found, the patentability determination system may generate a report listing the one or more functionalities against each of the prior art documents. The said report is then routed by the patentability determination system to a plurality of evaluators for receiving matching-level inputs for each of the granular-level functionalities. In an example, a list of the plurality of evaluators may be stored in the patentability determination system. The plurality of evaluators may include an inventor, an in-house IP attorney, an outside IP counsel, and other evaluators. In an example, the matching-level input is determinative of level of matching of each of the granular-level functionalities against the prior art documents found in the prior art search. Examples of the matching-level input may include low match, medium match, high match, full match, and not applicable. In an example, once the matching-level inputs are received for each and every granular-level functionality, the matching-level inputs are transformed into matching values. In an example, the matching values are represented in the form of percentage (%) values. For example, full match input may have 0% matching-level that of not applicable input may have 100% matching-level.

In one implementation, based on the importance-level inputs and the matching-level inputs received for the granular-level functionalities, the patentability determination system may calculate matching-level scores for the each and every granular-level functionality. For example, for a granular-level functionality, a matching-level score is calculated by multiplying individual values associated with the importance-level input and the matching-level input received for the said granular-level functionality. The process of calculating the matching-level score is performed till all the granular-level functionalities are assigned with corresponding matching-level scores.

Then, the patentability determination system may automatically compute an average of the matching-level scores of the granular-level functionalities and show against the respective high-level functionalities associated with the granular-level functionalities. For example, a high-level functionality is associated with three granular level functionalities having matching-level scores of 100, 200, and 300. Then, an average of the matching-level scores of the granular-level functionalities, i.e., 200, would be assigned as a matching-level score for the said high-level functionality. Such matching-level score of the high-level functionality is then transformed to a certain text which is visible to the plurality of evaluators, as described in greater detail in the sections that follow.

Further, once the matching-level scores are computed for all the granular-level functionalities and the high-level functionalities, the matching-level scores of both the granular-level functionalities and the high-level functionalities may be averaged separately per prior art document basis. That is, at an instant of time, an individual average score for the granular-level functionalities and an individual average score for the high-level functionalities are calculated based on a single prior art document. Similarly, the individual average scores of the granular-level functionalities and the high-level functionalities are calculated for remaining prior art documents found in the prior art search. The so calculated individual average scores for all the prior art documents are then averaged again to determine an overall patentability index value for the granular-level functionalities and an overall patentability index value for the high-level functionalities.

In an example, the patentability determination system then compares the overall patentability index value of the granular-level functionalities and the overall patentability index value of the high-level functionalities against a predetermined threshold to determine the patentability of the inventive idea against each of the prior art documents. In an example, the predetermined threshold is defined by a patent management group at an organization level, and may be revisited as the patent portfolio grows and the predetermined threshold may attain maturity. The predetermined threshold may also be referred to as an organizational baseline for patentability determination.

Thus, the systems and methods for patentability determination of the inventive idea facilitate the averaging of the individual matching-level inputs provided by the plurality of evaluators, which provides a value or benchmark for qualification of the inventive idea being filed as a patent. By having a value or benchmark for qualification, efficiency, quality, assurance, optimal use of resources, such as time and cost associated with patenting the inventive idea, may be increased.

These and other features of the present subject matter would be described in greater detail in conjunction with the following figures. While aspects of described systems and methods for patentability determination of the inventive idea can be implemented in any number of different computing systems, environments, and/or configurations, the embodiments are described in the context of the following exemplary system(s).

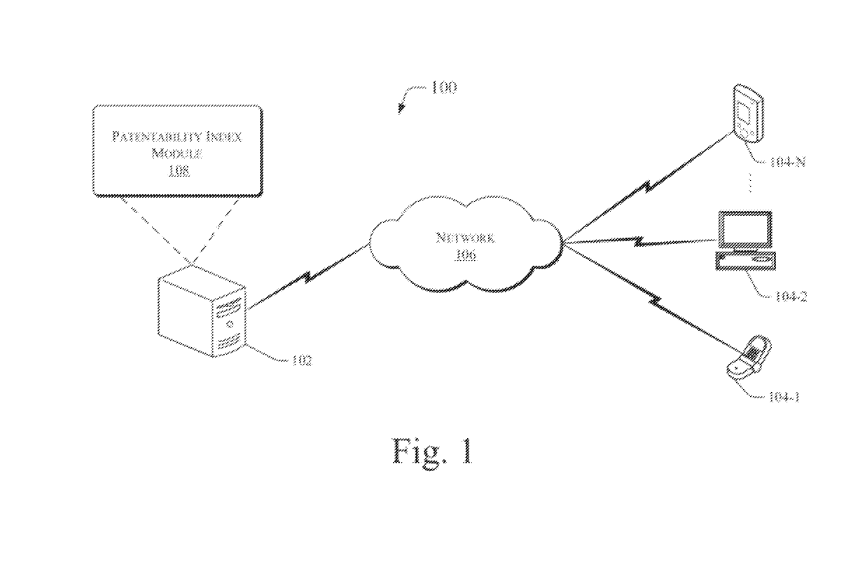

FIG. 1 illustrates a network environment 100 implementing a patentability determination system 102, according to an embodiment of the present subject matter. In said embodiment, the network environment 100 includes the patentability determination system 102 configured for patentability determination of an inventive idea in an enterprise. In one implementation, the patentability determination system 102 may be included within an existing information technology infrastructure or an existing intellectual property management system of an enterprise. For example, the patentability determination system 102 may be interfaced with the existing IP content and document management system, of the enterprise.

In one implementation, the patentability determination system 102 may be implemented in a variety of computing systems, such as a laptop computer, a desktop computer, a notebook, a workstation, a mainframe computer, a server, a network server, and the like. It will be understood that the patentability determination system 102 may be accessed by one or more users or evaluators, through one or more client devices 104-1, 104-2, 104-3 . . . 104-N, collectively referred to as client devices 104. Examples of the client devices 104 include, but are not limited to, a desktop computer, a portable computer, a mobile phone, a hand-held device, and a workstation. The client devices 104 may be used by end users of patent management group in an enterprise such as IP analysts, IP consultants, IP managers, IP Program Head, inventors, in-house IP attorney, outside IP counsel, such as patent agent, and system administrators.

As shown in FIG. 1, the client devices 104 are communicatively coupled to the patentability determination system 102 either directly or through a network 106 via wired, wireless, optical, or other types of network connections. The network 106 may be a single network or a combination of multiple networks. The network 106 may include one or more area networks, such as a local area network (LAN), a wide area network (WAN), an intranet, the internet, or any other type of network. The network 106 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the network 106 may include a variety of network devices, including routers, bridges, servers, computing devices, storage devices, etc. In an example, the network 106 may include a mobile communication network, for example, 2G, 3G or 4G mobile communication networks.

In an example, the patentability determination system 102 includes a patentability index module 108 configured for patentability determination of the inventive idea in the enterprise. In said example, the patentability index module 108 may be configured to generate various workflows to facilitate receiving matching-level inputs from a plurality of evaluators for each and every functionality against each prior art document found in a prior art search. In an example, the plurality of evaluators may include IP analysts, IP consultants, IP managers, IP program head, inventors, in-house IP attorney, outside IP counsel, and others. Further, the patentability index module 108 may be configured to generate various workflows to facilitate calculation of individual matching-level scores based in part on the matching-level inputs provided by the plurality of evaluators. The matching-level scores can be calculated based on any calculation techniques as would be known to those skilled in the art.

In an implementation, the patent index module 108 may be further configured to generate various workflows pertaining to development of patent portfolio of the enterprise. In one embodiment, the patent index module 108 facilitates aligning of business initiatives with acquisition of patents, landscape analysis, protecting a domain or technology using a cluster of patents, mapping patents with business offerings, etc.

In one implementation, the patent index module 108 may be configured to compute the patentability of inventive ideas of the patent portfolio of the enterprise based on various valuation techniques as would be known by those skilled in the art. The patent index module 108 may be further configured to determine a maturity index, indicative of the maturity level of each cross section of service and capability based on pre-configured rules.

In one embodiment, the patent index module 108 may be configured to generate various reports indicative of processes, workflows, maturity level of the enterprise in managing patents. Thus, the patent index module 108 facilitates managing patents in an enterprise. Further, the patent index module 108 may be configured to implement various frameworks, workflows, strategy, etc., for managing patents in the enterprise.

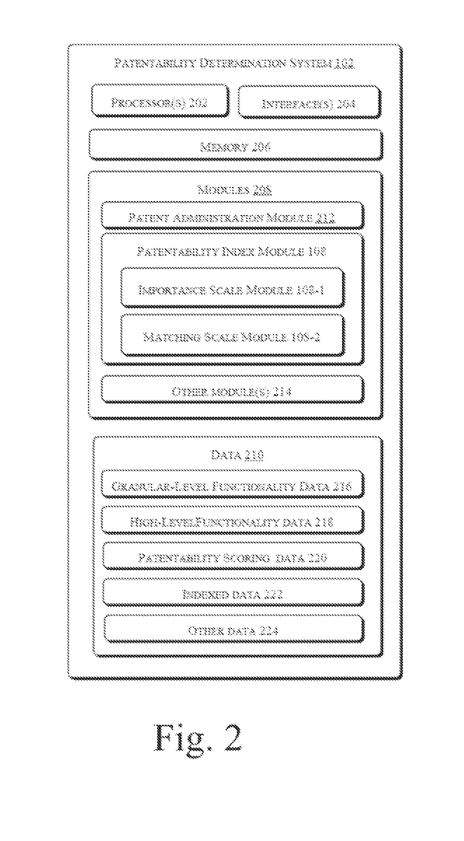

In one implementation, the patentability index module 108 may be further configured to average the individual matching-level scores obtained for the functionalities to calculate an individual average score of the functionalities for each of the prior art documents found in the prior art search. In an example, the average score is represented in the form of percentage (%) value. In one implementation, the individual average scores can be averaged to determine an overall patentability index value of the functionalities against all relevant prior art documents. Such overall patentability index value of the functionalities can be then compared against a predetermined threshold or base data of an overall patentability index to determine patentability of the inventive idea, as is explained in detail later with reference to FIG. 2.

FIG. 2 illustrates exemplary components of the patentability determination system 102, according to an embodiment of the present subject matter. In said embodiment, the patentability determination system 102 includes a processor(s) 202, an interface(s) 204, and a memory 206. The processor(s) 202 may be implemented as one or more microprocessors, microcomputers, microcontrollers, digital signal processors, central processing units, state machines, logic circuitries, and/or any devices that manipulate signals based on operational instructions. Among other capabilities, the processor(s) 202 is configured to fetch and execute computer-readable instructions stored in the memory 206.

The interface(s) 204 may include a variety of computer-readable instructions and hardware interfaces, for example, a web interface, a graphical user interface, etc., allowing the patentability determination system 102 to interact with the client devices 104. Further, the interface(s) 204 may enable the patentability determination system 102 to communicate with other computing devices, such as web servers and external data servers (not shown in figure). The interface(s) 204 can facilitate multiple communications within a wide variety of networks and protocol types, including wired networks, for example LAN, cable, etc., and wireless networks such as WLAN, cellular, or satellite. The interface(s) 204 may include one or more ports for connecting a number of devices to each other or to another server.

The memory 206 can include any computer-readable medium known in the art including, for example, volatile memory (e.g., RAM), and/or non-volatile memory (e.g., EPROM, flash memory, etc.). In one embodiment, the patentability determination system 102 includes module(s) 208 and data 210. The module(s) 208 usually includes routines, programs, objects, components, data structure, etc., that perform particular task or implement particular abstract data types.

In one implementation, the module(s) 208 further includes a patent administration module 212 and the patentability index module 108. The module(s) 208 may also include other modules 214 for providing various other functionalities of the patentability determination system 102. It will be appreciated that such modules may be represented as a single module or a combination of different modules. Additionally, the patentability determination system 102 further includes the data 210 that serves, amongst other things, as a repository for storing data fetched, processed, received and generated by one or more of the modules 208. In one implementation, the data 210 may include, for example, granular-level functionality data 216, high-level functionality data 218, patentability scoring data 220, indexed data 222, and other data 224. In one embodiment, the data 210 may be stored in the memory 206 in the form of data structures. Additionally, the aforementioned data can be organized using data models, such as relational or hierarchical data models.

As mentioned earlier, the patentability determination system 102 can be accessed by the end users using the client devices 104. In an example, the end users can be IP analysts, IP consultants, IP managers, IP program head, inventor(s), in-house IP attorney, and system administrators, of patent management group in the enterprise. In one implementation, the patent administration module 212 of the patentability determination system 102 may be configured to implement various access control mechanisms for the end users, based on role profiles of the end users. The patent administration module 212 may be configured to restrict access to various modules 208 and/or data 210, based on the privileges provided to the end users. In one implementation, various details pertaining to the end users, such as login credentials, access permissions, and personal details, may be required by the patent administration module 212 to provide access to various modules 208 and/or data 210.

In operation, when an inventor(s) comes up with a new inventive idea or a technical advancement in a field, the inventor(s) may prepare an invention disclosure file (IDF) containing inventive idea details, inventor details, and keywords related to the inventive idea. Once the IDF is prepared, the same is then submitted to the patent management group of the enterprise. The IDF may then be reviewed by in-house IP legal team, pertaining to the novelty of the inventive idea. In an example, the in-house IP legal team may review the IDF to determine whether the IDF is complete or whether the technology description of the inventive idea is understandable. In case the in-house IP legal team determines that the IDF is not complete or the technology is not understandable, the in-house IP legal team may notify the same to the inventor(s). Then, the inventor(s) may then make appropriate modifications in the IDF and resubmits the modified IDF. The modified IDF is then again reviewed and, based on the review, the in-house IP legal team of the enterprise may approve or deny further processing of the inventive idea to obtain patent protection.

Further, in an example, in case the in-house IP legal team approves the further processing of the inventive idea to obtain patent protection, the in-house IP legal team may add the IDF of the inventive idea in the patentability determination system 102. Once the IDF is added to the patentability determination system 102, the patent administration module 212 may initiate a process to receive functionalities to be furnished by the inventive idea from an end user, say the inventor(s). The functionalities may be understood as different features of the inventive idea or may be understood as different technical advancements of the inventive idea.

Further, in an example, the inventor(s) may provide the functionalities under two categories, i.e., high-level functionalities and granular-level functionalities. The high-level functionalities capture phrases of main features of the inventive idea, while the granular-level functionalities capture phrases of sub-features of the main features of the inventive idea. In view of that, a high-level functionality may be associated with a number of granular-level functionalities. The features of the inventive idea may be understood as elements of proposed patent claims for the inventive idea.

In an example, the following table, Table 1, depicts exemplary high-level functionalities and granular functionalities of an exemplary inventive idea relating to error logging.

TABLE 1
Exemplary Functionalities of the Inventive Idea

| S. No. | High-level Functionalities | Granular-level Functionalities |
|---|---|---|
| 1. | Error logging | Pop up error messages. |
| | | Log error messages. |
| | | Error logging at various levels. |
| 2. | Interface | Single interface for the user and |
| | | administrator. |
| | | Role based access to the single |
| | | interface. |
| 3. | Archiving error logs | Manual/automatic archiving of |
| | | error logs. |
| | | Viewing achieved error logs at |
| | | any point of time. |

Further, as can be concluded from Table 1, a high-level functionality is associated with a number of granular-level functionalities. In one implementation, the functionalities, including the granular-level functionalities and the high-level functionalities, received by the patent administration module 212 are stored as the granular functionality data 216 and the high-level functionality data 218 on the patent determination system 102.

In an example, the granular functionalities from the granular-level functionality data 216 are fetched by an importance scale module 108-1 of the patentability index module 108 for prioritizing the granular functionalities. For prioritizing, the importance scale module 108-1 presents the granular functionalities along with their corresponding high-level functionalities to the end user, say, the inventor(s). The inventor(s) then defines the importance of the granular-level functionalities by providing an importance-level input for all the granular-level functionalities. The importance-level input is determinative of level of importance of each of the functionalities in terms of novelty or uniqueness in a technical field. Examples of the importance-level input may include information, low importance, medium importance, high importance, and unique.

An exemplary prioritizing of the functionalities by the inventor(s) is represented in the following table, Table 2.

TABLE 2

| | | | Importance- |
|---|---|---|---|
| | High-level | Granular-level | level Input by |
| S. No. | Functionalities | Functionalities | an end user |
| 1. | Functionality 1 | Functionality 1.1 | Information |
| 2. | Functionality 2 | Functionality 2.1 | Information |
| 3. | | Functionality 2.2 | Medium Importance |
| 4. | | Functionality 2.3 | High Importance |
| 5. | Functionality 3 | Functionality 3.1 | Low Importance |
| 6. | | Functionality 3.2 | Unique |

In one implementation, the importance-level inputs received from the inventor(s) are transformed into importance values, based on any calculation techniques as would be known to those skilled in the art. In an example, the importance values may be represented in the form of percentage (%) values in accordance with a relation as depicted in following table, Table 3.

TABLE 3

| | Importance-level Input | | | | |
|---|---|---|---|---|---|
| | | Low | Medium | High | |
| | Information | Importance | Importance | Importance | Unique |
| Transformation to | 0 | 25 | 50 | 75 | 100 |
| percentage (%) value | | | | | |

Once the importance-level inputs are received for all the granular-level functionalities at the patentability determination system 102, the granular-level functionalities and the importance-level inputs are provided along with the IDF, to one or more of the inventor(s) and patent professionals, say, outside IP counsels or in-house attorneys. The inventor(s) or patent professionals may then perform an appropriate course of action including an initial prior art search based on the high-level functionalities and the granular-level functionalities. Prior art documents found on the basis of the functionalities are more focused towards the features of the inventive idea, in comparison to the prior art documents which would be found on the basis of conventional keyword-based search.

In an example, the prior art search can be conducted to find the prior art documents as defined in relevant patent laws. The prior art documents may include, but are not limited to, issued patents, published patent applications, non-patent literatures, published idea descriptions, published technical documents, and other publications.

In an example, the prior art search can be conducted to search various published patent applications, granted patents, and granted patents, of various jurisdictions such as India, The United States of America, Europe, Great Britain, Japan, Australia, Korea, Republic of China and Australia. Further, the prior art search can be conducted to search various non-patent literatures published in form of academic papers, research papers, journals, product brochures, white papers, case studies and so on.

Once the prior art documents are found, the matching scale module 108-2 may automatically contrast the functionalities of the inventive idea with the prior art documents found in the prior art search. The matching scale module 108-2 may then generate a report listing the functionalities against each of the prior art documents. The said report is then routed by the matching scale module 108-2 to a plurality of evaluators for receiving opinions and matching-level inputs for the granular-level functionalities. In an example, the plurality of evaluators may include an inventor, an in-house IP attorney, an outside IP counsel, and other evaluators. In an example, a list of the plurality of evaluators may be stored in the patentability determination system 102. Further, in an example, the opinions and the matching-level inputs received from one evaluator may not be visible to other evaluators.

In an example, the opinions of the plurality of evaluators may include one or two line sentence opinion about the importance, novelty, or patentability of the granular-level functionalities.

In an example, the matching-level input of the plurality of evaluators is determinative of level of matching of each of the granular-level functionalities against each of the prior art documents found in the prior art search. Examples of the matching-level input may include low match, medium match, high match, full match, and not applicable. In one implementation, the matching-level inputs are transformed into matching values, based on any calculation techniques as would be known to those skilled in the art. In an example, the matching values may be represented in the form of percentage (%) values in accordance with a relation as depicted in following table, Table 4.

TABLE 4

| | Matching-level Input | | | | |
|---|---|---|---|---|---|
| | | High- | Medium | Low | Not |
| | Full-Match | Match | Match | Match | Applicable |
| Transformation to | 0 | 25 | 50 | 75 | 100 |
| percentage (%) | | | | | |
| value | | | | | |

Once the matching-level inputs are received from the plurality of evaluators, the matching scale module 108-2 collates the matching-level inputs and the importance-level inputs in a single report. The following table, Table 5, represents an exemplary report depicting the importance-level inputs and the matching-level inputs.

TABLE 5

| | | Importance- | | Matching-level | Matching-level |
|---|---|---|---|---|---|
| | | level Inputs for | Matching-level | input for | input for |
| | | granular-level | input for | granular-level | granular-level |
| | | functionalities | granular-level | functionalities | functionalities |
| High-Level | Granular-Level | by an | functionalities | by in-house IP | by outside IP |
| Functionalities | Functionalities | inventor(s) | by inventor(s) | attorney(s) | counsel(s) |
| Functionality 1 | Functionality 1.1 | Information | Full Match | Not Applicable | Low Match |
| Functionality 2 | Functionality 2.1 | Information | Full Match | Full Match | Full Match |
| | Functionality 2.2 | Medium | Full Match | Medium Match | Medium Match |
| | | Importance | | | |
| | Functionality 2.3 | High | Full Match | Low Match | Not Applicable |
| | | Importance | | | |
| Functionality 3 | Functionality 3.1 | Low | Full Match | High Match | High Match |
| | | Importance | | | |
| | Functionality 3.2 | Unique | Full Match | Not Applicable | Not Applicable |

In an example, the Table 5 depicts the matching-level inputs received from the plurality of evaluators for the granular-level functionalities. Further, in the said example, the matching-level inputs received from one evaluator may not be visible to the other evaluator, which results in a non-biased evaluation of the granular-level functionalities of the inventive idea.

Further, in an example, once the matching-level inputs are received by the matching scale module 108-2, the matching scale module 108-2 may calculate matching-level scores corresponding to the matching-level inputs for all the granular-level functionalities. For example, for a granular-level functionality, a matching-level score is calculated by multiplying individual values tagged to the importance-level input and the matching-level input received for the said granular-level functionality.

For example, in case a granular-level functionality has an importance-level input of “High Importance” and a matching-level input of a “Low Match”, then values tagged to the “High Importance” and “Low Match”, i.e., 75 (High Importance)*75 (Low Match), are multiplied to determine the matching-level score of the said granular-level functionality. In this example, the matching-level score would be 5625, i.e., 75*75. Thereafter, the above-mentioned process of calculating the matching-level scores for the granular-level functionalities is performed till all the granular-level functionalities are assigned with corresponding matching-level scores.

Then, the patentability determination system can automatically compute an average of the matching-level scores of the granular-level functionalities and show against the respective high-level functionalities associated with the granular-level functionalities. For example, in case the matching-level score for the high-level functionality 3 of Table 5 has to be computed against the in-house IP attorney inputs, first, individual matching-level scores of the granular-level functionalities 3.1 and 3.2 have to be calculated. The individual matching-level score of the granular-level functionality 3.1 would be 625, i.e., 25 (Low Importance)*25 (High Match), and the individual matching-level score of the granular-level functionality 3.2 would be 10000, i.e., 100 (Unique)*100 (Not Applicable). Now, an average of the individual matching-level scores 625, 10000 is to be computed to determine the matching-level score for the high-level functionality 3. The average of the matching-level scores of the granular-level functionalities 3.1 and 3.2 would be 5312.5. Thereafter, the so calculated average is transformed into the matching-level score based on an exemplary relation as depicted in following table, Table 6.

TABLE 6

| | | | Transformation |
|---|---|---|---|
| | | | to Percentage |
| Start Bracket | End Bracket | Range based on Average | (%) Value |
| 0 | 0 | Only Information | 0 |
| 0 | 0 | Important but Full Match | 0 |
| 1 | 2500 | Low Importance and High | 25 |
| | | Match | |
| 2501 | 5000 | Medium Importance and | 50 |
| | | Medium Match | |
| 5001 | 7500 | High Importance and Low | 75 |
| | | Match | |
| 7501 | 10000 | Unique and Not Matched | 100 |

Based on the relation depicted in Table 6, the high-level functionality 3 would be assigned with a matching-level score of 75 as the value of average, i.e., 5312.5, lies in the range of “High Importance and Low Match”. Further, the high-level functionality having the matching-level score of 75 is tagged with a text “High Importance and Low Match” based on the relation depicted in Table 6.

In this way, the matching-level scores for the high-level functionalities are computed based on the matching-level scores of the granular level functionalities. The process of computing the matching-level scores for the high-level functionalities is performed till all the high-level functionalities are assigned with corresponding matching-level scores.

Once the matching-level scores are computed for all the granular-level functionalities and the high-level functionalities, the matching-level scores of both the granular-level functionalities and the high-level functionalities may be averaged separately to calculate an average score for the granular-level functionalities and an average score for the high-level functionalities.

In one implementation, the matching scale module 108-2 may calculate an average score for the granular-level functionalities and an average score for the high-level functionalities by averaging the matching-level scores of both the granular-level functionalities and the high-level functionalities, respectively.

In an example, for calculating the individual average score for all the granular-level functionalities, averaging of the matching-level scores of all the granular-level functionalities is performed on per prior art per evaluator basis. For example, for inventor's patentability index, an individual average score (Gran) for the granular-level functionalities for prior art document D1 is calculated on the basis of following equation:

$$Individual Average Score ( Gran ) per prior art = \frac{Sum of ( Importance Values * Matching Values )}{Number of Granular level functionalities}$$

Similarly, for calculating the individual average score for the high-level functionalities, averaging of the matching-level scores of the high-level functionalities is performed on per prior art per evaluator basis. For example, for inventor's patentability index, an individual average score (High) for the high-level functionalities for prior art document D1 is calculated on the basis of following equation:

$$Individual Average Score ( High ) per prior art = \frac{Sum of Matching level Scores of High level functionalities}{Number of High level functionalities}$$

Further, the individual average score for the granular-level functionalities and the individual average score for the high-level functionalities are computed separately against each of the prior art documents found in the prior art search for each of the plurality of evaluators. Then, based on the individual average score of the granular-level functionalities and the high-level functionalities, the patentability index module 108 may generate a patentability index in which different average scores of the granular-level functionalities and the high-level functionalities are listed against each of the prior art documents per evaluator basis. For example, the patentability index for the granular-level functionalities may include an individual average score of the plurality of evaluators, including inventor's average score, in-house IP attorney's average score, and outside IP counsel's average score. In one implementation, patentability index module 108 may store the patentability index as indexed data 222 in the patentability determination system 102. An exemplary patentability index is shown in following table, Table 7.

TABLE 7
Patentability Index of an Exemplary Inventive Idea

| | Inventor's Input | | In-house IP Attorney | | Outside IP Attorney | |
|---|---|---|---|---|---|---|
| | Granular-level | High-level | Granular-level | High-level | Granular-level | High-level |
| Prior Art | Functionalities | Functionalities | Functionalities | Functionalities | Functionalities | Functionalities |
| Prior Art1 | 85% | 60% | 85% | 65% | 85% | 65% |
| Prior Art 2 | 75% | 60% | 75% | 60% | 75% | 70% |
| Prior Art 3 | 90% | 65% | 90% | 65% | 90% | 65% |

Further, in an example, such patentability index for granular-level functionalities may facilitate in determining the patentability of the inventive idea, by averaging the individual average scores of the plurality of evaluators to determine an overall patentability index value for the granular-level functionalities. For example, for the granular level functionalities, an overall patentability index value may be computed by averaging individual average scores of the plurality of evaluators, including inventor's average score, in-house IP attorney's average score, and outside IP counsel's average score, for all the granular-level functionalities against all the prior art documents on the basis of following equation:

Overall Patentability Index (Granular−level Functionalities)=Average of individual average scores of the plurality of evaluators

Similarly, based on the individual average scores of the high-level functionalities, the patentability index module 108 may generate an overall patentability index value for the high-level functionalities. For example, the overall patentability index value for the high-level functionalities may by computed by averaging the individual average scores of the plurality of evaluators, including inventor's average score, in-house IP attorney's average score, and outside IP counsel's average score. Further, as described for the granular-level functionalities, the patentability index value for the high-level functionalities may be computed on the basis of following equation:

Overall Patentability Index (High−level Functionalities)=Average of individual average scores of the plurality of evaluators

In an example, the patentability determination system 102 then compares the overall patentability index value of the granular-level functionalities and the overall patentability index value the high-level functionalities against a predetermined threshold to determine the patentability of the inventive idea against each of the prior art documents. For example, in case the predetermined threshold is 80% for the granular-level functionalities and 60% for the high-level functionalities, then the inventive idea having the overall patentability index value below 80% for the granular-level functionalities and below 60% for the high-level functionalities can be denied for further processing of patenting by the organization.

However, in an example, in case the overall patentability index value is above the predetermined threshold for an inventive idea, the inventive idea is then processed for further processing, which may include patenting of the inventive idea.

In an example, the predetermined threshold is defined by the patent management group at an organization level, and may be revisited as the patents grow and the patentability determination system 102 receives more data grows and the attain maturity. The predetermined threshold may also be referred to as an organizational baseline patentability bracket.

Further, in an example, the patentability index may facilitate the patentability determination system 102 to determine the effectiveness of the prior art documents searched to challenge the patentability of the proposed inventive idea and novelty of the inventive idea based on the granular-level functionalities. That is, the patentability index communicates how effective the search has been. Thereby, the patentability index can be used by the plurality of evaluators to try and strengthen their search. On the flip side, the patentability index also communicates how strong the inventive idea is. For example, in case the average score for the high-level functionalities and the granular-level functionalities is below the predetermined threshold, then the end user or the inventor may provide more granular-level functionalities to improvise on the average score listed in the patentability index.

In another example, the patentability index may facilitate the patentability determination system 102 for ranking the high-level functionalities and granular-level functionalities for patentability preference based on the matching-level scores computed for intra high-level functionality (granular-level) and inter high-level functionality (granular-level) and High Level functionalities.

For example, there are 3 high-level functionalities and 6 granular-level functionalities arranged in the following way:
High Level functionality F1 has three granular level functionalities F1.1, F1.2 and F1.3.
High Level functionality F2 has two granular level functionalities F2.1, F2.2.
High Level functionality F3 has one granular level functionality F3.1.

In said example, a high-level functionality has at least one granular-level functionality associated with it. Further, each of the granular-level functionalities and the high-level functionality has a score associated with it, which has been computed based on the importance-level inputs and the matching-level inputs as described above.

In said example, for patentability preference: intra high level functionality (Granular Level), scores for the 6 granular functionalities, i.e., F1.1 to F3.1, are ranked against each other.

Similarly, in said example, for patentability preference of inter high level functionality (Granular Level), scores for the granular functionalities are ranked against each other only within the scope of the high level functionality, which it has been associated with. That is, F1.1 to F1.3 will be ranked against each other, F2.1 and F2.2 will be ranked against each other, and F3.1 will be ranked against itself.

In said example, for patentability preference of high level functionality, all high level functionalities are ranked against each other, i.e., F1 to F3 are ranked against each other.

Based on the ranking, the end user of the patentability determination system 102 may determine the functionalities that are ranked higher than others. Such high ranked functionalities may then be considered to organize patent claims for the inventive idea. In this way, the ranking of the functionalities may help in identifying the key features of the inventive idea which needs to be protected through patenting.

In yet another example, the patentability index may facilitate the patentability determination system 102 to drill down in the level of importance of the granular-level functionalities. Such drill down feature may facilitate an end user of the patentability determination system 102 to identify the percentage of the granular-level functionalities having high importance or uniqueness or novelty, and vice-versa. An exemplary drill down table, Table 8, is depicted below.

TABLE 8
Drill Down Details

| | Number of | |
|---|---|---|
| | Granular-level | Percentage |
| Importance categories | Functionalities | (%) |
| Category: Information | 1 | 6.2 |
| Category: Low | 2 | 12.5 |
| Category: Medium | 2 | 12.5 |
| Category: High | 5 | 31.25 |
| Category: Unique | 6 | 37.5 |

As can be seen from Table 8, six of the granular-level functionalities are categorized under unique category. That is, 37.5% of the granular-level functionalities are identified by the end user, say the inventor, as the unique or inventive features of the inventive idea. On the basis of these unique features, the determination of the patentability of the inventive idea is being conducted.

Thus, the systems and methods for patentability determination of the inventive idea facilitate the patentability determination of the inventive idea based on the granular-level functionalities and the high-level functionalities of the inventive idea. This provides a value/benchmark for qualification of the inventive idea being filed as a patent. Further, the systems and methods for patentability determination of the inventive idea also facilitates the saving of computing time and resources, as all data related to the patentability determination is created and maintained in a centralized location from where it can be accessed either, remotely or locally, by the plurality of evaluators.

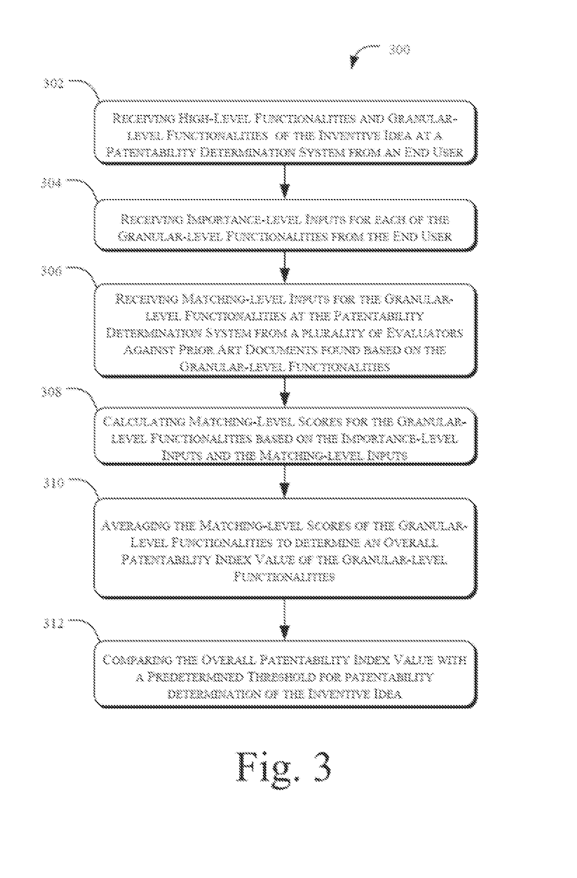

FIG. 3 illustrates an exemplary method 300 for patentability determination of an inventive idea, according to an embodiment of the present subject matter, whereas the method 300 may be described in the general context of computer executable instructions. Generally, computer executable instructions can include routines, programs, objects, components, data structures, procedures, modules, and functions, which perform particular functions or implement particular abstract data types. The method 300 may also be practiced in a distributed computing environment where functions are performed by remote processing devices that are linked through a communication network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300, or alternative methods. Additionally, individual blocks may be deleted from the method 300 without departing from the scope of the subject matter described herein. Furthermore, the methods 300 can be implemented in any suitable hardware, computer readable medium, firmware, or combination thereof.

With reference to method 300 as depicted in FIG. 3, as shown in block 302, the method 300 may include receiving granular-level functionalities and high-level functionalities of the inventive idea at a patentability determination system 102 from an end user. In an example, the end user can be an inventor who comes up with the inventive idea. The functionalities may be referred to as different features of the inventive idea or as a technical advancement in the existing field. Further, each of the granular-level functionalities is associated with one of the high-level functionalities.

At block 304, the method 300 may include receiving importance-level inputs for each of the granular-level functionalities at the patentability determination system 102 from the end user.

At block 306, the method 300 may include receiving matching-level inputs for each of the granular-level functionalities at the patentability determination system 102 from a plurality of evaluators. The plurality of evaluators may include one of an inventor, an in-house intellectual property attorney, and an outside intellectual property counsel. The matching-level inputs may be received against plurality of prior art documents found based on the one or more functionalities. In an example, the prior art documents may be understood as published documents that are contrasting with the granular-level functionalities of the inventive idea.

At block 308, the method 300 may include calculating matching-level scores for the granular-level functionalities based on the importance-level inputs and the matching-level inputs.

At block 310, the method 300 may include averaging the matching-level scores of the granular-level functionalities to determine an overall patentability index value of the granular-level functionalities.

At block 312, the method 300 may include comparing the overall patentability index value of the granular-level functionalities with a predetermined threshold for patentability determination of the inventive idea.

Thus, the patentability determination system 102 facilitates the patentability determination of the inventive idea in an enterprise. The systems and method for patentability determination as described in the present subject matter are generic and platform independent and thus can be used for various types of systems. Although embodiments for the patentability determination have been described in language specific to structural features and/or methods, it is to be understood that the invention is not necessarily limited to the specific features or methods described. Rather, the specific features and methods are disclosed as exemplary implementations for managing the sustainable intellectual property portfolio of the enterprise.

I/We claim:

1. A method for patentability determination of an inventive idea at a patentability determination system, the method comprising:
receiving high-level functionalities and granular-level functionalities of the inventive idea at the patentability determination system from an end user, wherein each of the granular-level functionalities is associated with one of the high-level functionalities;
receiving importance-level inputs for each of the granular-level functionalities at the patentability determination system from the end user;
receiving matching-level inputs for each of the granular-level functionalities against prior art documents at the patentability determination system from a plurality of evaluators;
calculating matching-level scores for the granular-level functionalities based on the importance-level inputs and the matching-level inputs;
averaging the matching-level scores of the granular-level functionalities to determine an overall patentability index value of the granular-level functionalities; and
comparing the overall patentability index value of the granular-level functionalities with a predetermined threshold to determine patentability of the inventive idea.

2. The method as claimed in claim 1, wherein the method further comprises computing matching-level scores for the high-level functionalities based on the matching-level scores of the granular-level functionalities.

3. The method as claimed in claim 2, wherein the computing comprises averaging the matching-level scores of the granular-level functionalities to compute the matching-level scores for the high-level functionalities.

4. The method as claimed in claim 3, wherein the method further comprises:
averaging the matching-level scores of the high-level functionalities to determine an overall patentability index value for the high-level functionalities; and
comparing the overall patentability index value for the high-level functionalities with a predetermined threshold to determine patentability of the inventive idea.

5. The method as claimed in claim 1, wherein the method further comprises finding the prior art documents based on phrases from the granular-level functionalities and phrases from the high-level functionalities, and wherein the prior art documents comprises any of issued patents, published patent applications, non-patent literatures, and published technical documents.

6. The method as claimed in claim 1, wherein the plurality of evaluators comprises at least one of an inventor, an in-house intellectual property attorney, and an outside intellectual property counsel.

7. The method as claimed in claim 1, wherein the calculating of the matching-level scores for the granular-level functionalities comprises:
transforming the importance-level inputs into importance values;
transforming the matching-level inputs into matching values; and
multiplying the importance values and the matching values to calculate the matching-level scores for the granular-level functionalities.

8. The method as claimed in claim 1, wherein the comparing comprises denying the patentability of the inventive idea when the overall patentability index value is below the predetermined threshold.

9. A patentability determination system for determination of patentability of an inventive idea, the patentability determination system comprises:
a processor; and
a patent administration module, coupled to the processor, to receive high-level functionalities and granular-level functionalities of the inventive idea from an end user, wherein each of the granular-level functionalities is associated with one of the high-level functionalities; and
a patentability index module, coupled to the processor, to:
receive importance-level inputs for each of the granular-level functionalities from the end user,
receive matching-level inputs for each of the granular-level functionalities against prior art documents from a plurality of evaluators,
calculate matching-level scores for the granular-level functionalities based on the importance-level inputs and the matching-level inputs,
average the matching-level scores of the granular-level functionalities to calculate an overall patentability index value of the granular-level functionalities, and
compare the overall patentability index value of the granular-level functionalities with a predetermined threshold to determine patentability of the inventive idea.

10. The patentability determination system as claimed in claim 9, wherein the prior art documents comprises any of issued patents, published patent applications, non-patent literatures, and published technical documents.

11. The patentability determination system as claimed in claim 9, wherein the patentability index module:
compute matching-level scores for the high-level functionalities based on the matching-level scores of the granular-level functionalities;
average the matching-level scores of the high-level functionalities to determine an overall patentability index value for the high-level functionalities; and
compare the overall patentability index value for the high-level functionalities with a predetermined threshold to determine patentability of the inventive idea.

12. The patentability determination system as claimed in claim 9, wherein the plurality of evaluators comprises at least one of an inventor, an in-house intellectual property attorney, and an outside intellectual property counsel.

13. The patentability determination system as claimed in claim 9, wherein the patentability index module comprises a matching-scale module coupled to the processor, to:
transform the importance-level inputs for the granular-level functionalities into importance values;
transform the matching-level inputs for the granular-level functionalities into matching values; and
multiply the importance values and the importance values to calculate the matching-level scores for the granular-level functionalities.

14. The patentability determination system as claimed in claim 13, wherein matching-scale module averages the matching-level scores calculated for the granular-level functionalities to compute the matching-level scores for the high-level functionalities.

15. A non-transitory computer-readable medium having a set of computer readable instructions that, when executed, cause a processor to:
receive high-level functionalities and granular-level functionalities of the inventive idea from an end user, wherein each of the granular-level functionalities is associated with one of the high-level functionalities;
receive importance-level inputs for each of the granular-level functionalities from the end user;
receive matching-level inputs for each of the granular-level functionalities against prior art documents from a plurality of evaluators;
calculate matching-level scores for the granular-level functionalities based on the importance-level inputs and the matching-level inputs;
average the matching-level scores of the granular-level functionalities to calculate an overall patentability index value of the granular-level functionalities; and
compare the overall patentability index value of the granular-level functionalities with a predetermined threshold to determine patentability of the inventive idea.

16. The non-transitory computer-readable medium as claimed in claim 15, further cause the processor to:
compute matching-level scores for the high-level functionalities based on the matching-level scores of the granular-level functionalities;
average the matching-level scores of the high-level functionalities to determine an overall patentability index value for the high-level functionalities; and
compare the overall patentability index value for the high-level functionalities with a predetermined threshold to determine patentability of the inventive idea.

17. The non-transitory computer-readable medium as claimed in claim 15, wherein the plurality of evaluators comprises at least one of an inventor, an in-house intellectual property attorney, and an outside intellectual property counsel.

18. The non-transitory computer-readable medium as claimed in claim 15, further cause the processor to:
transform the importance-level inputs for the granular-level functionalities into importance values;
transform the matching-level inputs for the granular-level functionalities into matching values; and
multiply the importance values and the importance values to calculate the matching-level scores for the granular-level functionalities.
